(19) United States
(12) Patent Application Publication
(10) Pub. No.: US 2020/0387554 A1
(43) Pub. Date: Dec. 10, 2020

(54) APPARATUS FOR COLLECTING USER RATINGS OF WEB PAGES AND OF WEBSITES

(71) Applicant: Zsolt István HAJDARA, Budapest (HU)

(72) Inventor: Zsolt István HAJDARA, Budapest (HU)

(21) Appl. No.: 16/535,164

(22) Filed: Aug. 8, 2019

(30) Foreign Application Priority Data
Jun. 4, 2019 (HU) U1900092

(51) Int. Cl. G06F 16/951; G06F 16/957; G06F 16/958

(52) U.S. Cl. CPC G06F 16/951; G06F 16/958; G06F 16/9577

(57) ABSTRACT

An apparatus for collecting user ratings of web pages and websites utilizes a rating server and user terminals connected to the rating server via telecommunications network. The apparatus includes: a display; a user rating recording unit; a sending unit transmitting the address, user rating, and user identifier to the server; a statistical calculator; a statistic sending unit to transmit the statistics to the terminal; and a statistic display. The apparatus enables rating not only the websites but also the web pages located on the websites individually. The apparatus allows rating by several criteria, such as emotional, scientific or empirical. Numerical scales, on which ratings are recorded, allow sophisticated and nuanced ratings. Previous ratings do not influence the user rating. Therefore, the user does not able to know other users' rating before his/her own rating of the web page.

### BACKGROUND OF THE INVENTION

### Field of the Invention

The subject of the invention is an apparatus for collecting user ratings of web pages and of websites by means of a rating server and a plurality of user terminals connected to the rating server via telecommunications network, comprising
a means for displaying on a user terminal a web page located on a website,
a means for recording user rating of said website on the user terminal on a multi-point numerical scale,
a means for sending the address of said website, said user rating and a user identifier from the user terminal to the rating server,
a means for calculating statistics on the rating server from the user ratings sent,
a means for sending the statistics calculated on the rating server from the rating server to said user terminal in answer to a request of the user terminal, and
a means for displaying on said user terminal the statistics calculated on the rating server.

In the description, website refers to the totality of web pages located under a single domain name. For retrieving web pages, various user terminals are available, including desktop computers, laptops, smartphones and tablets. These user terminals access the web pages of the websites located on the World Wide Web via telecommunications network.

### Description of the Related Art

Recently, the number of web pages located on the World Wide Web, useful and useless alike, has increased considerably. A variety of web pages contains incorrect information and fake news, which makes it difficult to retrieve reliable information.

It is known that the choice between useful and useless web pages is supported by an apparatus with a rating server and a plurality of user terminals connected to the rating server via telecommunications network. That apparatus comprises a means for displaying on a user terminal a web page located on a website; a means for recording user rating of said website on the user terminal on a multi-point numerical scale; a means for sending the address of said website, said user rating and a user identifier from the user terminal to the rating server, a means for calculating statistics on the rating server from the user ratings sent; a means for sending the statistics calculated on the rating server from the rating server to said user terminal in answer to a request of the user terminal, and a means for displaying on said user terminal the statistics calculated on the rating server. Such an apparatus is presented on the web page with the following address: https://chrome.google.com/webstore/detail/wot-web-of-trust-website/bhmmomiinigofkjcapegjjindpbikblnp. The apparatus comprises a browser extension described on the above-mentioned web page. The apparatus allows users to rate the visited websites on a single, multi-point numerical scale; different criteria of user rating are therefore not separated. The multi-point numerical scale is just a 1 to 5 scale that enables only a superficial assessment. Web pages cannot be rated individually; rating of each web page refers to the website.

### SUMMARY OF THE INVENTION

The invention aims at eliminating the disadvantages of the above mentioned realisation by creating an apparatus that enables to rate not only the websites but also the web pages located on the websites individually. Another objective is that the apparatus allows the user to do rating by several criteria, such as emotional, scientific or empirical. Further objective is that numerical scales, on which ratings are recorded, allow the rating to be sophisticated enough and nuanced. Further objective is that previous ratings do not influence the user rating; therefore, the apparatus shall be such that the user is not able to know other users' rating before his/her own rating of the web page. Further objective is that rating statistics can be queried both on web pages and on websites containing the rated web pages.

In accordance with the objectives above, the invention is an apparatus for collecting user ratings of web pages and of websites by means of a rating server and a plurality of user terminals connected to the rating server via telecommunications network, comprising a means for displaying on a user terminal a web page located on a website, a means for recording user rating of said website on the user terminal on a multi-point numerical scale, a means for sending the address of said website, said user rating and a user identifier from the user terminal to the rating server, a means for calculating statistics on the rating server from the user ratings sent, a means for sending the statistics calculated on the rating server from the rating server to said user terminal in answer to a request of the user terminal, and a means for displaying on said user terminal the statistics calculated on the rating server. The invention is characterised in that
the means for recording user rating of said website on a multi-point numerical scale is a means for recording the user rating of said web page by multiple different assessment criteria on numerical scales of at least nine points for each criterion;
the means for sending the address of said website, said user rating and a user identifier from the user terminal to the rating server is a means for sending the address of said web page, said user rating and a user identifier from the user terminal to the rating server;
the apparatus comprises a means for calculating web page statistics on the rating server from the user ratings of said web page, and, only after the arrival of the user rating of said web page from said user terminal to the rating server, sending the calculated web page statistics for said user terminal in answer to a statistics query received from said user terminal on said web page statistics, and displaying the calculated web page statistics on said user terminal; and
the apparatus comprises a means for calculating website statistics on the rating server from the user ratings of the web pages of said website, and, only after the arrival of the user rating of at least one of the web pages of said website from said user terminal to the rating server, sending the calculated statistics for said user terminal in answer to a query received from said user terminal on said website statistics, and displaying the calculated statistics on said user terminal.

A preferred embodiment of the invention is characterised in that the type of web page statistics and of website statistics calculated on the rating server is selected from: mean, median, standard deviation, variance and covariance.

A further preferred embodiment of the invention is characterised in that the user rating criteria include assessment of the truth content of said web page based on theoretical considerations, empirically based assessment of the truth content of said web page, and emotional assessment of said web page.

A further preferred embodiment of the invention is characterised in that
the apparatus comprises a means for assigning user identifiers to group identifiers indicating belonging to professional communities;
the apparatus comprises a means for calculating web page statistics on the rating server from those user ratings of said web page, that are submitted with user identifiers assigned to a selected group identifier, and, only after the arrival of the user rating of said web page from said user terminal to the rating server, sending the calculated web page statistics for said user terminal in answer to a query received from said user terminal on web page statistics of said web page filtered by the selected group identifier, and displaying the calculated web page statistics on said user terminal; and
the apparatus comprises a means for calculating website statistics on the rating server from those user ratings of the web pages of said website, that are submitted with user identifiers assigned to a selected group identifier, and, only after the arrival of the user rating of at least one of the web pages of said website from said user terminal to the rating server, sending the calculated statistics for said user terminal in answer to a statistics query received from said user terminal on said website statistics filtered by the selected group identifier, and displaying the calculated statistics on said user terminal.

### BRIEF DESCRIPTION OF THE DRAWINGS

The invention is presented below with the aid of a drawing, wherein

FIG. 1 is a communication block diagram of a preferred embodiment of the invention.

### DESCRIPTION OF THE PREFERRED EMBODIMENTS

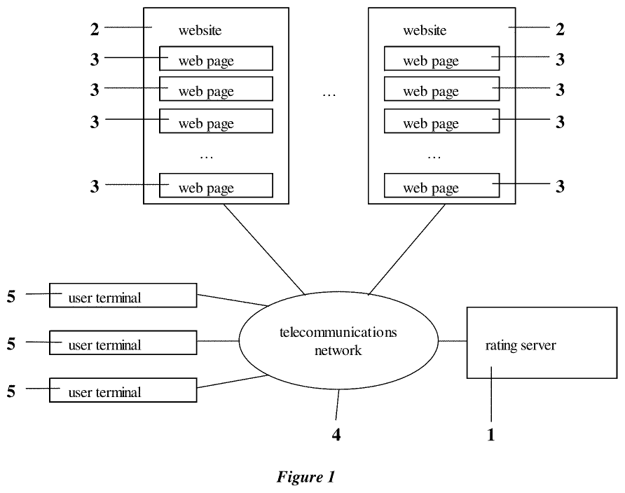

As shown in FIG. 1, the rating server 1, the websites 2 and the user terminals 5 are connected via telecommunications network 4, and websites 2 contain web pages 3. As an example, three user terminals 5 and two websites 2 are represented, but their number may be different without changing the essentials of the invention.

A preferred embodiment of the apparatus in accordance with the invention is an apparatus for collecting user ratings of web pages 3 and of websites 2 by means of a rating server 1 and a plurality of user terminals 5 connected to the rating server 1 via telecommunications network 4, comprising
a means for displaying on a user terminal 5 a web page 3 located on a website 2;
a means for recording user rating of said web page 3 on the user terminal 5 by multiple different assessment criteria on numerical ten-point scales going from 1 to 10 for each criterion;
a means for sending the address of said web page 3, said user rating and a user identifier from the user terminal 5 to the rating server 1;
a means for calculating statistics on the rating server 1 from the user ratings sent;
a means for calculating web page statistics on the rating server 1 from the user ratings of said web page 3, and, only after the arrival of the user rating of said web page 3 from said user terminal 5 to the rating server 1, sending the calculated web page statistics for said user terminal 5 in answer to a query received from said user terminal 5 on said web page statistics, and displaying the calculated web page statistics on said user terminal 5;
a means for calculating website statistics on the rating server 1 from the user ratings of the web pages 3 of said website 2, and, only after the arrival of the user rating of at least one of the web pages 3 of said website 2 from said user terminal 5 to the rating server 1, sending the calculated statistics for said user terminal 5 in answer to a query received from said user terminal 5 on said website statistics, and displaying the calculated statistics on said user terminal 5.

In this embodiment, the type of web page statistics and of website statistics calculated on the rating server 1 is selected from: mean, median, standard deviation, variance and covariance. The user rating criteria include assessment of the truth content of said web page 3 based on theoretical considerations, empirically based assessment of the truth content of said web page 3, and emotional assessment of said web page 3.

A further embodiment of the apparatus in accordance with the invention further comprises a means for assigning user identifiers to group identifiers indicating belonging to professional communities, a means for calculating web page statistics on the rating server 1 from those user ratings of said web page 3, that are submitted with user identifiers assigned to a selected group identifier, and, only after the arrival of the user rating of said web page 3 from said user terminal 5 to the rating server 1, sending the calculated web page statistics for said user terminal 5 in answer to a query received from said user terminal 5 on web page statistics of said web page filtered by the selected group identifier, and displaying the calculated web page statistics on said user terminal 5, a means for calculating website statistics on the rating server 1 from those user ratings of the web pages 3 of said website 2, that are submitted with user identifiers assigned to a selected group identifier, and, only after the arrival of the user rating of at least one of the web pages 3 of said website 2 from said user terminal 5 to the rating server 1, sending the calculated statistics for said user terminal 5 in answer to a query received from said user terminal 5 on said website statistics filtered by the selected group identifier, and displaying the calculated statistics on said user terminal 5.

Time-stamping and avoidance of postmodification of ratings may be assured by blockchain technology.

The apparatus in accordance with the invention is used by users surfing the World Wide Web. After viewing a certain web page 3, the user can rate that web page 3. The ratings of said web page 3 are stored on the rating server 1. Website statistics and/or web page statistics are displayed on the user terminal 5 only after said web page has been rated with the user's user identifier. The opportunity of getting to know the website statistics and the web page statistics is the user's reward in return for the rating. If the user changes his/her mind, he/she can submit a new rating on the user terminal 5. The change over time of the ratings is traceable, if the submission time of ratings is recorded on the rating server 1.

Technical advantages of the apparatus in accordance with the invention are the following:
enables the user to rate not only the websites 2, but also the web pages 3 located on the websites 2 individually;
the apparatus allows the user to do rating by several criteria, such as emotional, scientific or empirical;
the above mentioned ratings can be executed freely, several times over time, so that the change over time of ratings can be studied;
numerical scales used to record the rating allow the rating to be sophisticated enough and nuanced;
the apparatus enables user ratings not to be influenced by previous ratings;
rating statistics can be queried both on rated web pages 3 and on websites 2 containing rated web pages 3.

### LIST OF REFERENCE SIGNS

1 rating server

2 websites

3 web pages

4 telecommunications network

5 user terminals

1. An apparatus for collecting user ratings of web pages (3) and of websites (2) by means of a rating server (1) and a plurality of user terminals (5) connected to the rating server (1) via telecommunications network (4), comprising:
a. a means for displaying on a user terminal (5) a web page (3) located on a website (2);
b. a means for recording user rating of said website (2) on the user terminal (5) on a multi-point numerical scale;
c. a means for sending the address of said website (2), said user rating and a user identifier from the user terminal (5) to the rating server (1);
d. a means for calculating statistics on the rating server (1) from the user ratings sent;
e. a means for sending the statistics calculated on the rating server (1) from the rating server (1) to said user terminal (5) in answer to a request of the user terminal (5);
f. a means for displaying on said user terminal (5) the statistics calculated on the rating server (1);
wherein
g. the means for recording user rating of said website (2) on a multi-point numerical scale is a means for recording the user rating of the web page (3) by multiple different assessment criteria on numerical scales of at least nine points for each criterion;
h. the means for sending the address of said website (2), said user rating and a user identifier from the user terminal (5) to the rating server (1) is a means for sending the address of said web page (3), said user rating and a user identifier from the user terminal (5) to the rating server (1);
i. the apparatus comprises a means for calculating web page statistics on the rating server (1) from the user ratings of said web page (3), and, only after the arrival of the user rating of said web page (3) from said user terminal (5) to the rating server (1), sending the calculated web page statistics for said user terminal (5) in answer to a query received from said user terminal (5) on said web page statistics, and displaying the calculated web page statistics on said user terminal (5);
j the apparatus comprises a means for calculating website statistics on the rating server (1) from the user ratings of the web pages (3) of said website (2), and, only after the arrival of the user rating of at least one of the web pages (3) of said website (2) from said user terminal (5) to the rating server (1), sending the calculated website statistics for said user terminal (5) in answer to a query received from said user terminal (5) on said website statistics, and displaying said website statistics on said user terminal (5).

2. The apparatus according to claim 1, wherein the type of web page statistics and of website statistics calculated on the rating server (1) is selected from mean, median, standard deviation, variance and covariance.

3. The apparatus according to claim 1, wherein the user rating criteria include assessment of the truth content of said web page (3) based on theoretical considerations, empirically based assessment of the truth content of said web page (3), and emotional assessment of said web page (3).

4. The apparatus according to claim 1, wherein
a. the apparatus comprises a means for assigning user identifiers to group identifiers indicating belonging to professional communities;
b. the apparatus comprises a means for calculating web page statistics on the rating server (1) from those user ratings of the web page (3), that are submitted with user identifiers assigned to a selected group identifier, and, only after the arrival of the user rating of said web page (3) from said user terminal (5) to the rating server (1), sending the calculated web page statistics for the user terminal (5) in answer to a query received from said user terminal (5) on web page statistics of said web page (3) filtered by the selected group identifier, and displaying web page statistics on said user terminal (5);
c. the apparatus comprises a means for calculating website statistics on the rating server (1) from those user ratings of the web pages (3) of said website (2), that are submitted with user identifiers assigned to a selected group identifier, and, only after the arrival of the user rating of at least one of web pages (3) of said website (2) from the user terminal (5) to the rating server (1), sending the calculated statistics for said user terminal (5) in answer to a query received from said user terminal (5) on said website statistics filtered by the selected group identifier, and displaying the calculated statistics on said user terminal (5).

5. The apparatus according to claim 2, wherein the user rating criteria include assessment of the truth content of said web page (3) based on theoretical considerations, empirically based assessment of the truth content of said web page (3), and emotional assessment of said web page (3).

6. The apparatus according to claim 2, wherein
a. the apparatus comprises a means for assigning user identifiers to group identifiers indicating belonging to professional communities;
b. the apparatus comprises a means for calculating web page statistics on the rating server (1) from those user ratings of the web page (3), that are submitted with user identifiers assigned to a selected group identifier, and, only after the arrival of the user rating of said web page (3) from said user terminal (5) to the rating server (1), sending the calculated web page statistics for the user terminal (5) in answer to a query received from said user terminal (5) on web page statistics of said web page (3) filtered by the selected group identifier, and displaying web page statistics on said user terminal (5);
the apparatus comprises a means for calculating website statistics on the rating server (1) from those user ratings of the web pages (3) of said website (2), that are submitted with user identifiers assigned to a selected group identifier, and, only after the arrival of the user rating of at least one of web pages (3) of said website (2) from the user terminal (5) to the rating server (1), sending the calculated statistics for said user terminal (5) in answer to a query received from said user terminal (5) on said website statistics filtered by the selected group identifier, and displaying the calculated statistics on said user terminal (5).

7. The apparatus according to claim 3, wherein
a. the apparatus comprises a means for assigning user identifiers to group identifiers indicating belonging to professional communities;
b. the apparatus comprises a means for calculating web page statistics on the rating server (1) from those user ratings of the web page (3), that are submitted with user identifiers assigned to a selected group identifier, and, only after the arrival of the user rating of said web page (3) from said user terminal (5) to the rating server (1), sending the calculated web page statistics for the user terminal (5) in answer to a query received from said user terminal (5) on web page statistics of said web page (3) filtered by the selected group identifier, and displaying web page statistics on said user terminal (5);
the apparatus comprises a means for calculating website statistics on the rating server (1) from those user ratings of the web pages (3) of said website (2), that are submitted with user identifiers assigned to a selected group identifier, and, only after the arrival of the user rating of at least one of web pages (3) of said website (2) from the user terminal (5) to the rating server (1), sending the calculated statistics for said user terminal (5) in answer to a query received from said user terminal (5) on said website statistics filtered by the selected group identifier, and displaying the calculated statistics on said user terminal (5).

8. The apparatus according to claim 5, wherein
a. the apparatus comprises a means for assigning user identifiers to group identifiers indicating belonging to professional communities;
b. the apparatus comprises a means for calculating web page statistics on the rating server (1) from those user ratings of the web page (3), that are submitted with user identifiers assigned to a selected group identifier, and, only after the arrival of the user rating of said web page (3) from said user terminal (5) to the rating server (1), sending the calculated web page statistics for the user terminal (5) in answer to a query received from said user terminal (5) on web page statistics of said web page (3) filtered by the selected group identifier, and displaying web page statistics on said user terminal (5);
the apparatus comprises a means for calculating website statistics on the rating server (1) from those user ratings of the web pages (3) of said website (2), that are submitted with user identifiers assigned to a selected group identifier, and, only after the arrival of the user rating of at least one of web pages (3) of said website (2) from the user terminal (5) to the rating server (1), sending the calculated statistics for said user terminal (5) in answer to a query received from said user terminal (5) on said website statistics filtered by the selected group identifier, and displaying the calculated statistics on said user terminal (5).
